(19) United States
(12) Patent Application Publication
(10) Pub. No.: US 2016/0358082 A1
(43) Pub. Date: Dec. 8, 2016

(54) Customized Browser Out of Box Experience

(71) Applicant: Microsoft Technology Licensing, LLC, Redmond, WA (US)

(72) Inventor: Megan Marie Quintero, Seattle, WA (US)

(73) Assignee: MICROSOFT TECHNOLOGY LICENSING, LLC, Redmond, WA (US)

(21) Appl. No.: 14/733,958

(22) Filed: Jun. 8, 2015

(51) Int. Cl. G06N 5/04

(52) U.S. Cl. CPC G06N 5/04

(57) ABSTRACT

In one embodiment, a user device and a server may implement a user archetype to customize a first impression of an application for a user. A user device may maintain a data usage history of a user. The user device may tailor a user experience aspect of an application based on a user archetype matched to the data usage history. The user device may present the user experience aspect of the application.

### BACKGROUND

A user may execute an application on a user device. The user device may provide access to computing resources for the application via an operating system. The computing resources may be data storage, processing, output devices, input device, a communication interface, and other more specialized devices. The user device may have a communication interface to connect the user device to a data network, such as the Internet. The user may customize the user device by selecting specific brands of applications, for example choosing a Safari® browser or a Chrome® browser. The user may further customize an application configuration of a specific application by activating specific features and installing specific plug-ins.

### SUMMARY

This Summary is provided to introduce a selection of concepts in a simplified form that is further described below in the Detailed Description. This Summary is not intended to identify key features or essential features of the claimed subject matter, nor is it intended to be used to limit the scope of the claimed subject matter.

Embodiments discussed below relate to implementing a user archetype to customize a first impression of an application for a user. A user device may maintain a data usage history of a user. The user device may tailor a user experience aspect of an application based on a user archetype matched to the data usage history. The user device may present the user experience aspect of the application.

### DRAWINGS

In order to describe the manner in which the above-recited and other advantages and features can be obtained, a more particular description is set forth and will be rendered by reference to specific embodiments thereof which are illustrated in the appended drawings. Understanding that these drawings depict only typical embodiments and are not therefore to be considered to be limiting of its scope, implementations will be described and explained with additional specificity and detail through the use of the accompanying drawings.

FIG. 1 illustrates, in a block diagram, one embodiment of a computing network.

FIG. 2 illustrates, in a block diagram, one embodiment of a computing device.

FIG. 3 illustrates, in a block diagram, one embodiment of a computer architecture.

FIG. 4 illustrates, in a block diagram, one embodiment of an archetype generation system.

FIG. 5 illustrates, in a block diagram, one embodiment of an archetype refinement system.

FIG. 6 illustrates, in a block diagram, one embodiment of an archetype selection system.

FIG. 7 illustrates, in a block diagram, one embodiment of a data usage history.

FIG. 8 illustrates, in a block diagram, one embodiment of an application package.

FIG. 9 illustrates, in a flowchart, one embodiment of a method of crafting a user experience with a user device.

FIG. 10 illustrates, in a flowchart, one embodiment of a method of tailoring a user experience aspect with a user device.

FIG. 11 illustrates, in a flowchart, one embodiment of a method of crafting a user experience with an application server or an archetype server.

FIG. 12 illustrates, in a flowchart, one embodiment of a method of tailoring a user experience aspect with an application server.

FIG. 13 illustrates, in a flowchart, one embodiment of a method of developing a user archetype.

### DETAILED DESCRIPTION

Embodiments are discussed in detail below. While specific implementations are discussed, it should be understood that this is done for illustration purposes only. A person skilled in the relevant art will recognize that other components and configurations may be used without parting from the spirit and scope of the subject matter of this disclosure. The implementations may be a user device, a tangible machine-readable medium having a set of instructions detailing a method stored thereon for at least one processor, or a machine-implemented method.

In one embodiment, a user device and a server may implement a user archetype to customize a first impression of an application for a user. A user archetype is a general model of a user created by comparing the attributes of multiple users to create a profile of certain user types. The user device may also implement the user archetype when migrating and storing application data, such as plug-ins and bookmarks for a browser. A user device may maintain a data usage history of a user describing the data use habits of a user. The user device may tailor a user experience aspect of an application based on a user archetype matched to the data usage history. The user experience aspect describes a facet of a user interaction with an application, such as the configuration of the application or communications from the application to the user. The user device may present the user experience aspect of the application.

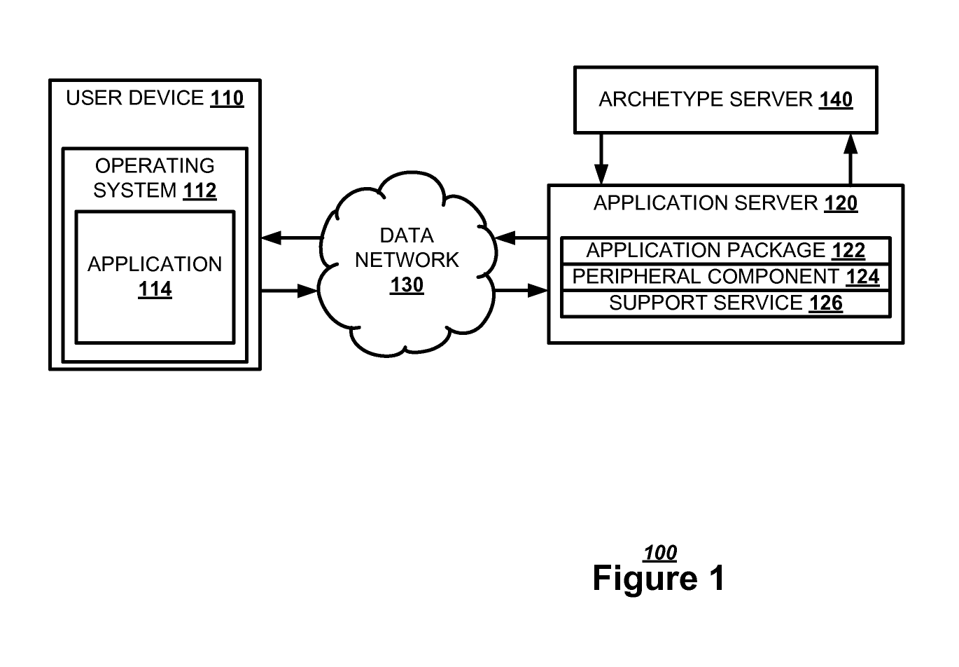

FIG. 1 illustrates, in a block diagram, one embodiment of a computing network 100. A user device 110 may implement an operating system 112 to execute an application 114 resident on the operating system 112. The user device 110 may use the operating system 112 or the application 114 to access an application server 120 via a data network connection 130. The application server 120 may provide an initial instance download of the application 114 in an application package 122, peripheral software components 124 for the application 114, and other support services 126 for the application 114. The application server 120 may be implemented on a single server or a distributed set of servers, such as a server farm. The data network connection 130 may be an internet connection, a wide area network connection, a local area network connection, or other type of data network connections.

The operating system 112 may provide the application server 120 with a data usage history of the user device 110. The operating system 112 may appropriately anonymize the data usage history to protect the privacy of the user. The data usage history may describe the data interactions of various applications resident on the user device 110, such as web browsers, email applications, telecommunications applications, and other applications that the user interacts with regularly. The application server 120 may consult an archetype server 140 to select a user archetype for the user of the user device based on the data usage history. The archetype server 140 may be a separate server or may be a part of the same server as the application server 120. The application server 120 may then tailor a user experience aspect of the application 114 based on the user archetype to improve user interactions with the application 114. A user experience aspect may be the first impression configuration of the application 114 that the user receives when initially downloading the application 114, a user communication that the operating system uses to communicate with the user regarding the application 114, an advertisement for the application that the user may view, or other interactions with the user.

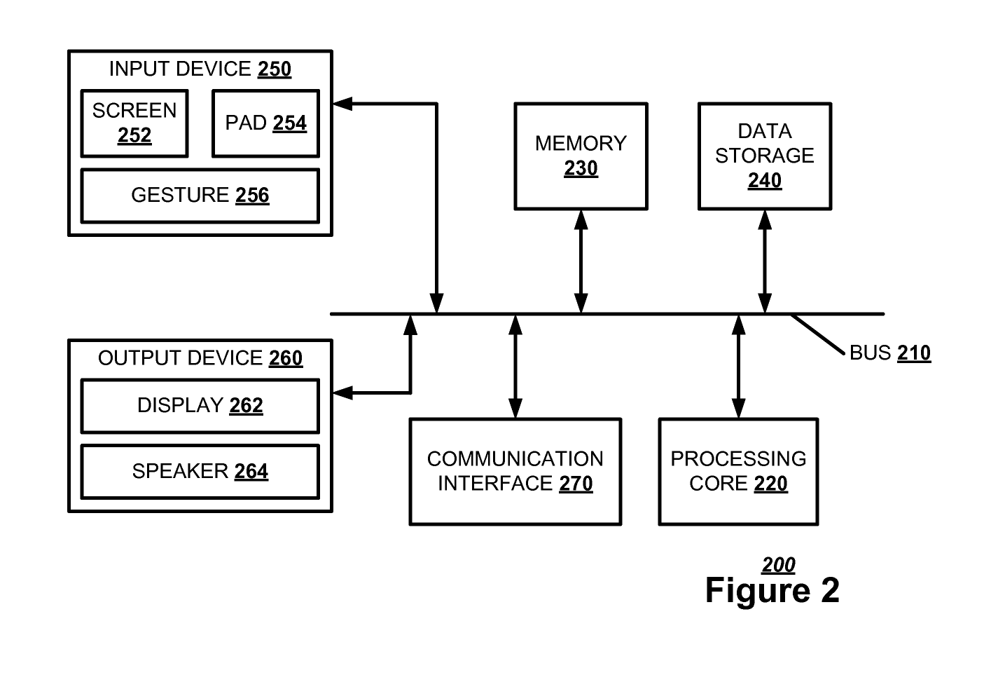

FIG. 2 illustrates a block diagram of an exemplary computing device 200 which may act as a user device, an application server, or an archetype server. The computing device 200 may combine one or more of hardware, software, firmware, and system-on-a-chip technology to implement a user device, an application server, or an archetype server. The computing device 200 may include a bus 210, a processing core 220, a memory 230, a data storage 240, an input device 250, an output device 260, and a communication interface 270. The bus 210, or other component interconnection, may permit communication among the components of the computing device 200.

The processing core 220 may include at least one conventional processor or microprocessor that interprets and executes a set of instructions. The at least one processor further may be configured to execute an operating system to monitor the data usage history of the user. The at least one processor also may be configured to anonymize the data usage history of the user. The at least one processor may be configured to match a data usage history to a user archetype. The at least one processor further may be configured to tailor a user experience aspect of an application based on a user archetype matched to the data usage history. The at least one processor additionally may be configured to select an application configuration for the application based on a user archetype. The at least one processor also may be configured to select an application communication from an application communication subset of the set of communications associated with the application based on the user archetype. An application communication is a message from an application presented by the operating system to the user. The at least one processor may further be configured to automatically adjust an application configuration of the application based upon an application usage history. An application usage history is a data usage history focused on a specific application. The at least one processor additionally may be configured to apply an application stimulus to the user. An application stimulus is an action by the application that provokes a stimulus response from the user.

The memory 230 may be a random access memory (RAM) or another type of dynamic data storage that stores information and instructions for execution by the processor 220. The memory 230 may also store temporary variables or other intermediate information used during execution of instructions by the processor 220. The memory 230 may be configured to maintain a data usage history of a user. The data usage history may have at least one of a default application selection, a usage time of an application instance, a feature usage of the application instance, or other data about user habits. The default application selection describes which application is set as the default version of the application for the user. The usage time describes the amount of time that the user actively uses an application. The feature usages describes the amount or percentage of time that the user implements a feature of the application.

The data storage 240 may include a conventional ROM device or another type of static data storage that stores static information and instructions for the processor 220. The data storage 240 may include any type of tangible machine-readable medium, such as, for example, magnetic or optical recording media, such as a digital video disk, and its corresponding drive. A tangible machine-readable medium is a physical medium storing machine-readable code or instructions, as opposed to a signal. Having instructions stored on computer-readable media as described herein is distinguishable from having instructions propagated or transmitted, as the propagation transfers the instructions, versus stores the instructions such as can occur with a computer-readable medium having instructions stored thereon. Therefore, unless otherwise noted, references to computer-readable media/medium having instructions stored thereon, in this or an analogous form, references tangible media on which data may be stored or retained. The data storage 240 may store a set of instructions detailing a method that when executed by one or more processors cause the one or more processors to perform the method. The data storage 240 may also be a database or a database interface for accessing a set of stored user archetypes and associated user experience aspects.

The input device 250 may include one or more conventional mechanisms that permit a user to input information to the computing device 200, such as a keyboard, a mouse, a voice recognition device, a microphone, a headset, a touch screen 252, a touch pad 254, a gesture recognition device 256, etc. The output device 260 may include one or more conventional mechanisms that output information to the user, including a display screen 262, a printer, one or more speakers 264, a headset, a vibrator, or a medium, such as a memory, or a magnetic or optical disk and a corresponding disk drive. The output device 260 may be configured to present a user experience aspect of an application.

The communication interface 270 may include any transceiver-like mechanism that enables computing device 200 to communicate with other devices or networks. The communication interface 270 may include a network interface or a transceiver interface. The communication interface 270 may be a wireless, wired, or optical interface. The communication interface 270 may be configured to send a data usage history to an application server or an archetype server. The communication interface 270 further may be configured to download the application with an application configuration based on the user archetype to the user. The communication interface 270 also may be configured to receive an application communication subset for the application based on the user archetype. The communication interface 270 additionally may be configured to report a stimulus response of a user to an application server. If the user device matches the data usage history to a user archetype, the communication interface 270 may be configured to send a user archetype for the user to an application server.

The computing device 200 may perform such functions in response to processor 220 executing sequences of instructions contained in a computer-readable medium, such as, for example, the memory 230, a magnetic disk, or an optical disk. Such instructions may be read into the memory 230 from another computer-readable medium, such as the data storage 240, or from a separate device via the communication interface 260.

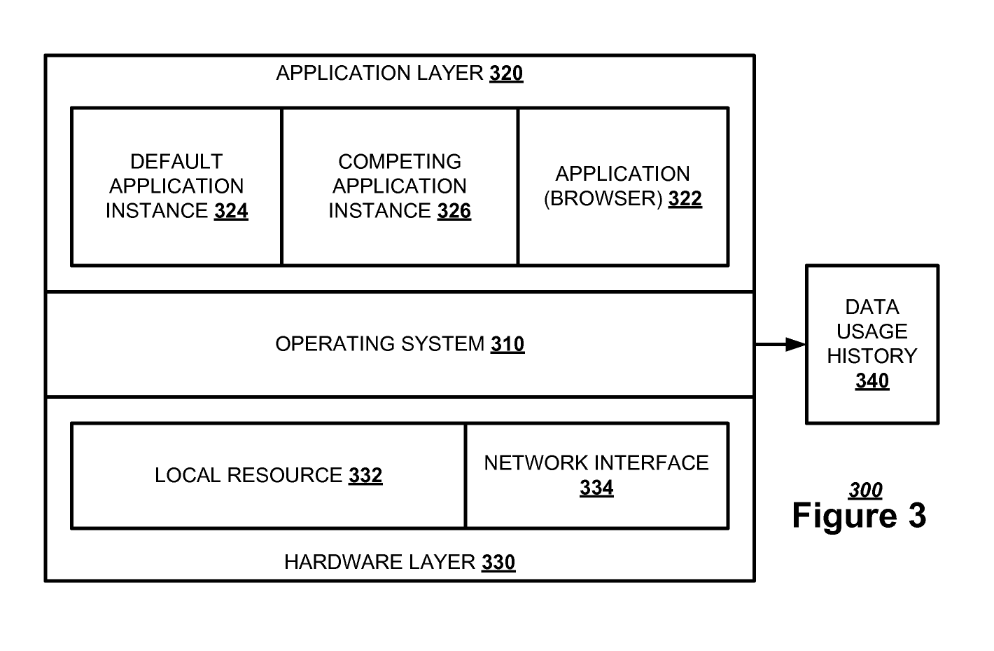

FIG. 3 illustrates, in a block diagram, one embodiment of a computer architecture 300. The user device may have an operating system 310 that facilitates communication between the application layer 320 and the hardware layer 330. One or more applications 322 may execute at the application layer 320, such as a browser, an e-mail application, a word processor, or other applications. The application layer 320 may have multiple versions of the same application 322, either from the same developer or competing developers. The user may select a default application instance 324, so that if the user device calls for an application type, the default application instance 324 is initiated. The application layer 320 may have a competing application instance 426 of the same type as the default application instance 324, but of a different version or a different brand.

The application 322 may access local resources 332 at the hardware layer 330 via the operating system 310, such as a processor, a data storage, a memory, or other hardware devices. The application 322 may use a network interface 334 to access remote resources via the data network. The operating system 310 may track inter-layer communications between the application layer 320 and the hardware layer 330. The operating system 310 may store a data usage history 340 describing the inter-layer communications in a memory or data storage at the hardware layer 330.

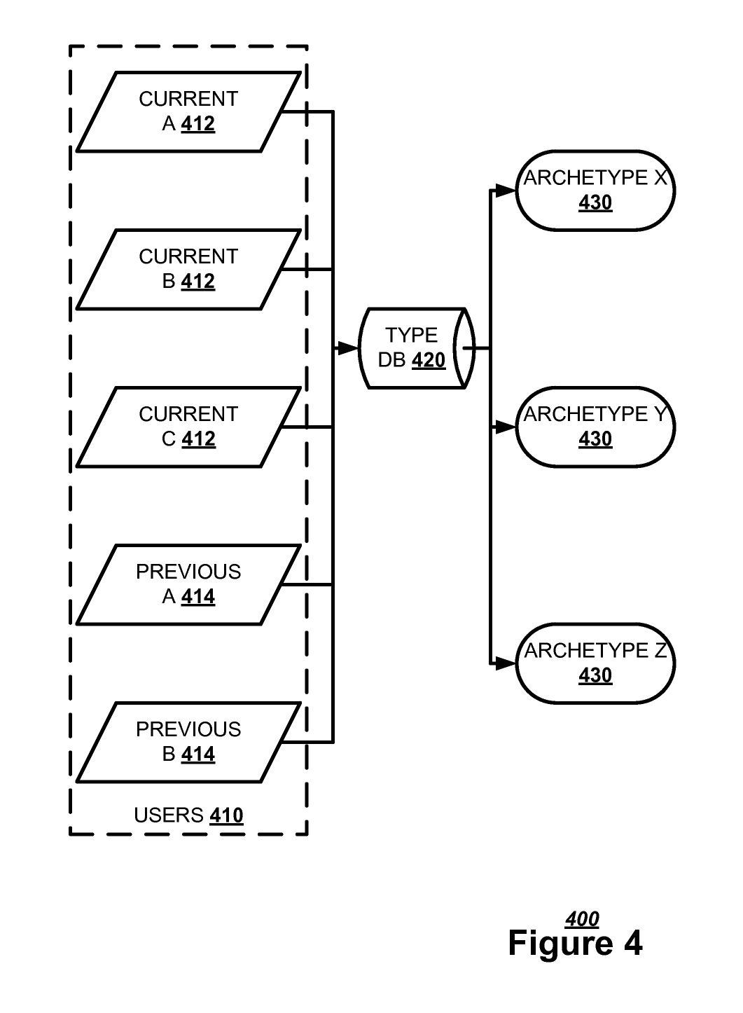

FIG. 4 illustrates, in a block diagram, one embodiment of an archetype generation system 400. The archetype generation system 400 may collect a data usage history for multiple users 410 in an archetype database 420. The users 410 may be current users 412 of an operating system or other computing platform or previous users 414. The archetype database 420 may use the data usage history to create one or more user archetypes 430. A default application instance may have a strong correlation with the application that the user 410 predominantly uses. The archetype generation system may leverage the data points of the data usage history to provide the most personalized onboarding experience for the user in a new application instance. For example, a browser may have a unique position to recruit user study participants allowing a complete study of user profiles as well as generating stimuli to apply to the user study participants. Based off of these studies, the archetype generation system 400 may generate a user archetype 430 for future classification of users 410.

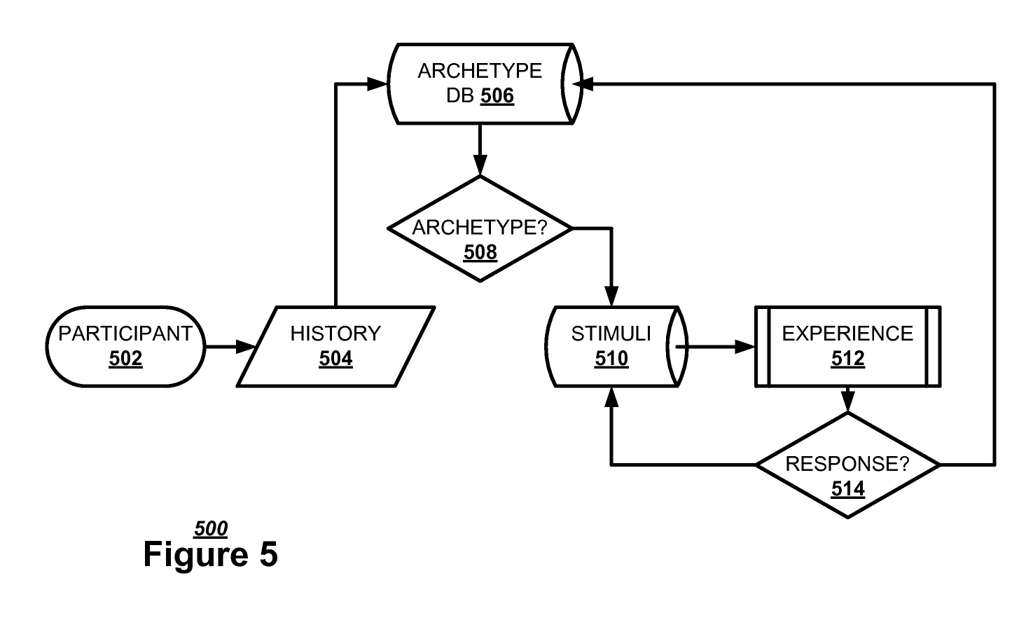

FIG. 5 illustrates, in a block diagram, one embodiment of an archetype refinement system 500. An archetype refinement system 500 may use a user study to further refine a user archetype. A user study participant 502 may provide a data usage history 504 to an archetype database 506. The archetype refinement system 500 may select a user archetype 508 for the user study participant 502 based on the data usage history 504. The archetype refinement system 500 may select a set of user stimuli 510 associated with that user archetype 508 to apply to the user study participant 502. The user stimuli 510 may be application communications, an application configuration, an application feature, or other user experience aspects. The archetype refinement system 500 may execute an experience sub-process 512 to apply the selected user stimuli 510 to the user study participant 502. The user study participant 502 may provide a stimulus response 514 to the archetype refinement system 500. The user study participant 502 may categorize a reaction as positive, negative, or neutral in the stimulus response 514. The archetype refinement system 500 may adjust the user archetype 506 based on the stimulus response.

The archetype refinement system 500 may present an iteratively generated specific experience to different user types. The archetype refinement system 500 may show a single experience approach to multiple user types to determine which experiences resonate with which type of user. Eventually, the archetype refinement system 500 may map each user type to a subset of experiences and configurations that are most likely to generate adoption and engagement of an application. For example, one user archetype may be more likely to launch one brand of application on upgrade. The archetype refinement system 500 may show a user study participant a message that highlights a value proposition of an alternative brand of the application that is not offered by original application. Additionally, the archetype refinement system 500 may show a convenience user type a message that helps them find a later version of an application as easily and quickly as possible.

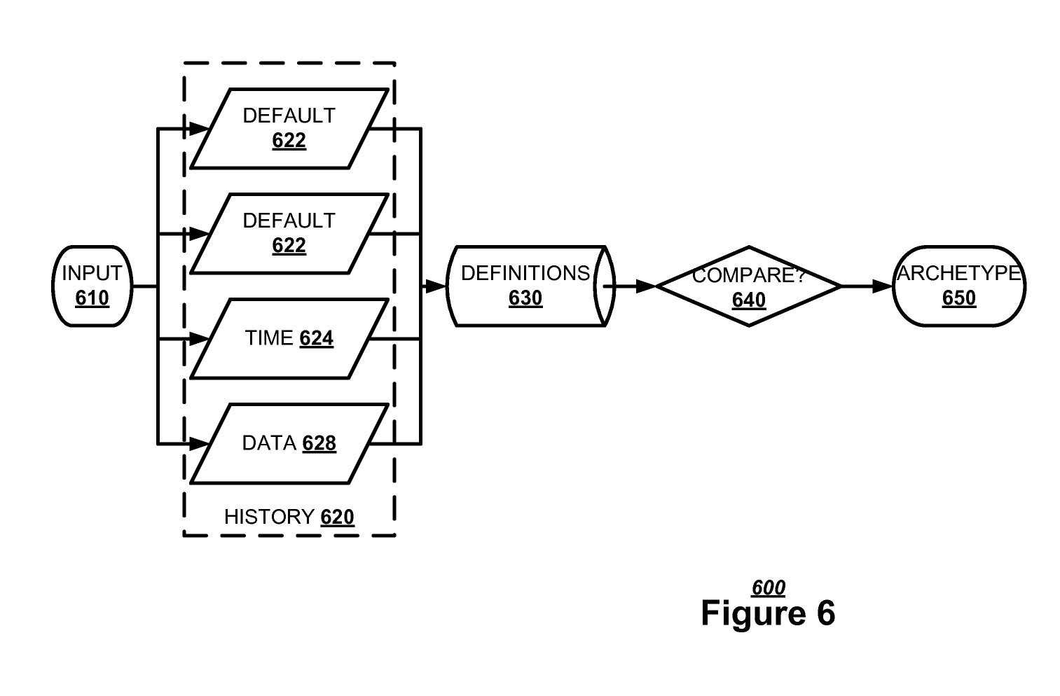

FIG. 6 illustrates, in a block diagram, one embodiment of an archetype selection system 600. The archetype selection system 600 may receive a user input 610 of a data usage history 620. The data usage history 620 may have the default application instance 622, the time 624 spent in the application instance, the feature usage 626 in the application, and other configuration data 628. The archetype selection system 600 may select a set of user definitions 630 based upon the type of data input. The archetype selection system 600 may compare 640 the user definitions 630 to the data usage history 620 to select a user archetype 650 for the user.

After the archetype selection system 600 may parse through the data usage history to map the user to a pre-defined user archetype. The archetype selection system 600 may then show content more likely to be relevant to a user. The archetype selection system 600 may then use the user archetype to entice a user to try a new brand or version of an application or retain the user during a version transition. The user device may then present to the user application communications after an upgrade, during a discoverability issue, during launch of a competing application instance, and once in the chosen application instance. For example, a user with Internet Explorer® set as a default who spends 80% of browsing time in Internet Explorer® and 20% in Chrome® may be classified as a first user archetype. The archetype system may tailor a user experience aspect for that user based on the first user archetype.

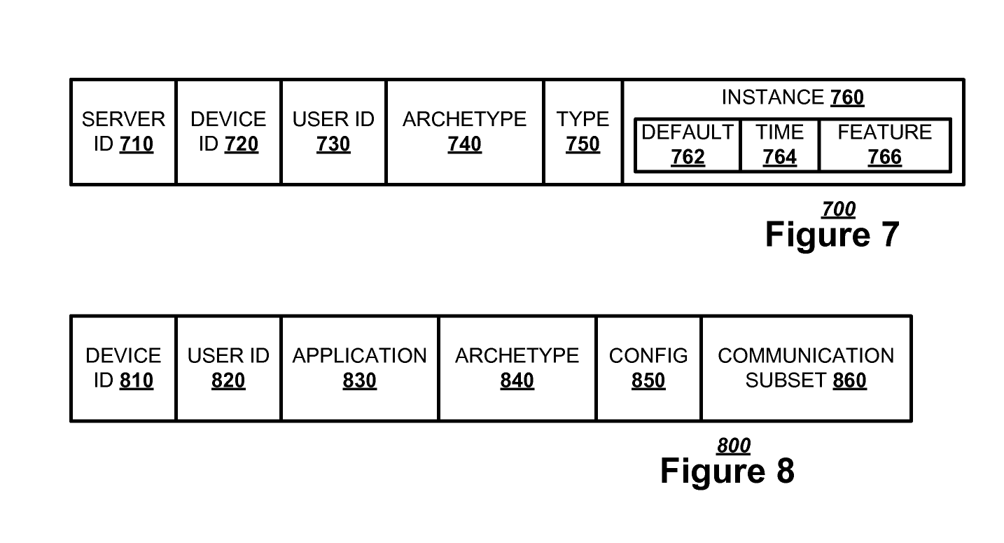

The user device may send a data usage history to a server. The server may be an application server supporting a single application, a developer server supporting multiple applications, or an archetype server supporting multiple developers. FIG. 7 illustrates, in a block diagram, one embodiment of a data usage history 700. The data usage history 700 may have a server identifier (ID) 710 to identify the server that is the target of the data usage history 700. The data usage history 700 may have a device identifier 720 identifying the user device sending the data usage history 700. The data usage history 700 may have a user identifier 730 identifying a specific user when multiple users have access for the device. The user device or the server may obfuscate the device identifier 720 and the user identifier 730 to protect the privacy of the user. If the user archetype matching occurs at the user device, the data usage history 700 may have a user archetype field 740 identifying a user archetype for the user. The data usage history 700 may have an application type field 750 describing one or more types of applications tracked by the operating system of the user device. For each application type, the data usage history 700 may have an application instance field 760 describing each application instance of the application type present on the user device. For each application instance, the data usage history 700 may have a default flag 762 indicating whether that application instance is the default application instance, a time usage field 764 describing a usage time for that application instance, and a feature usage field 766 describing a feature usage of that application instance.

An application server may then send an application package to the user device. FIG. 8 illustrates, in a block diagram, one embodiment of an application package 800. The application package 800 may have a device identifier 810 identifying the user device that is the target of the application package 800. The application package 800 may have a user identifier 820 identifying the user that is the target of the customization. The application package 800 may have an application executable 830 to be downloaded to the user. The application package 800 may have a user archetype field 840 identifying the user archetype matched to the user. The application package 800 may have an application configuration 850 for the application for a user archetype. The application package 800 may have an application communication subset 860 for the application based on the user archetype.

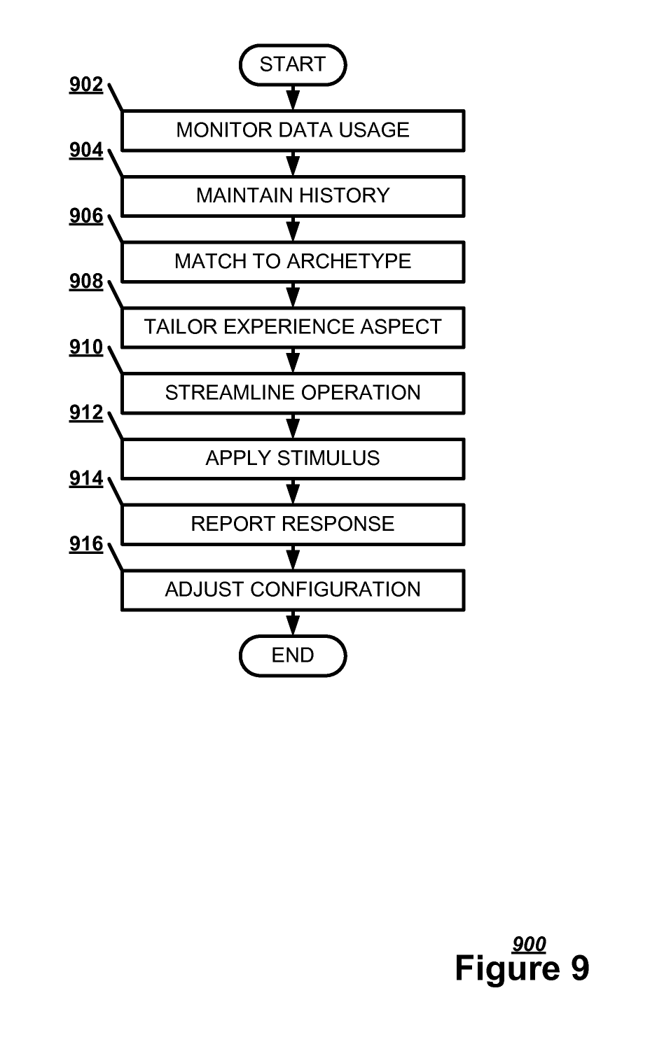

FIG. 9 illustrates, in a flowchart, one embodiment of a method 900 of crafting a user experience with a user device. The user device may monitor a data usage of a user with the operating system (Block 902). The user device may maintain a data usage history of the user (Block 904). The user device may match the user to a user archetype based on the data usage history (Block 906). Alternately, the user device may send the data usage history to a server for matching to a user archetype at the server. The user device may tailor a user experience aspect of an application, such as a browser, based on the user archetype (Block 908). The user device may streamline the operation tasks for the application based on the user archetype (Block 910). The user device may apply an application stimulus to a user (Block 912). The user device may report a stimulus response of a user to an application server (Block 914). The user device automatically may adjust an application configuration of the application based upon the application usage history after the application has been installed (Block 916). For example, the user device automatically may adjust a browser configuration of a browser based upon the browser usage history after the browser has been installed.

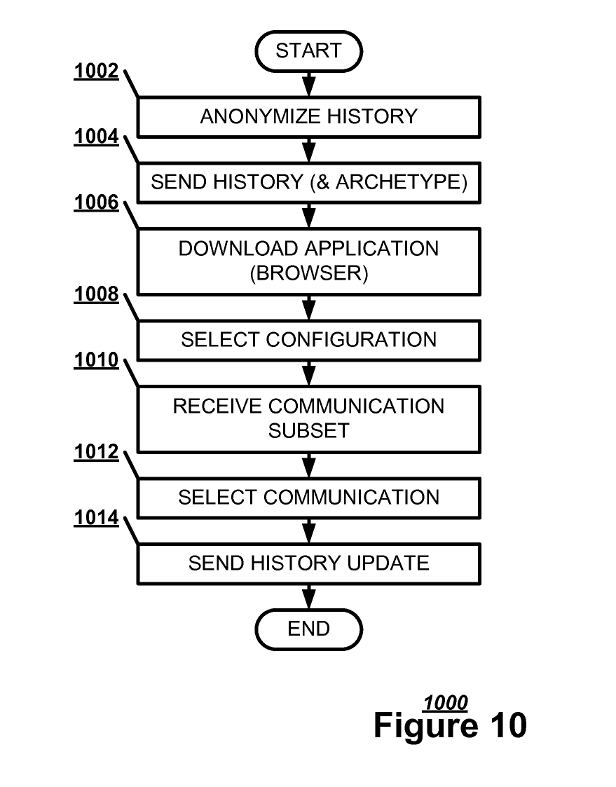

FIG. 10 illustrates, in a flowchart, one embodiment of a method 1000 of tailoring a user experience aspect with a user device. The user device may anonymize the data usage history of the user (Block 1002). The user device may send a data usage history for the user to an archetype server or an application server to be matched to a user archetype (Block 1004). Alternately, the user device may match the data usage history to the user archetype and send the user archetype to the application server. The user device may download an application package, such as a browser package, based on the user archetype of the user (Block 1006). The application package may have at least an application executable, an application configuration, or a user archetype. The user device may select an application configuration for the application based on the user archetype (Block 1008). The user device may receive an application communication subset for the application, such as a browser communication subset for the browser, based on the user archetype in the application package (Block 1010). The user device may select an application communication from the application communication subset for the application based on the user archetype (Block 1012). The user device may send a data usage history update to the application server (Block 1014).

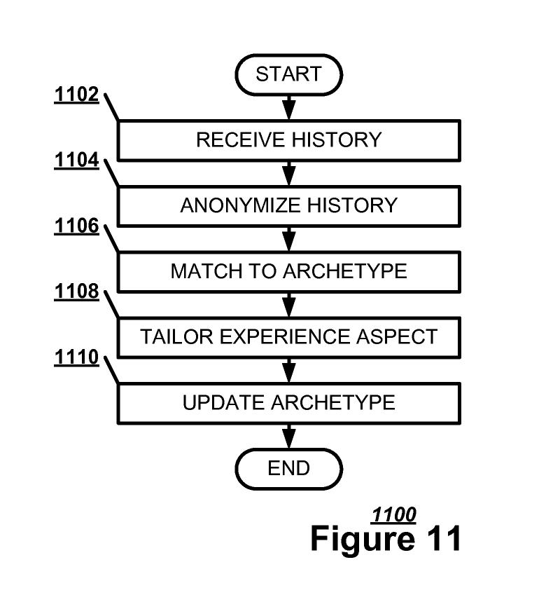

FIG. 11 illustrates, in a flowchart, one embodiment of a method 1100 of crafting a user experience with an application server or an archetype server. The application server or an archetype server may receive a data usage history of a user (Block 1102). The application server or an archetype server may anonymize the data usage history of the user (Block 1104). The application server or an archetype server may match the user to a user archetype based on the data usage history (Block 1106). The application server or an archetype server may tailor a user experience aspect of an application based on the user archetype (Block 1108). The application server or an archetype server may update the user archetype based on the data usage history (Block 1110).

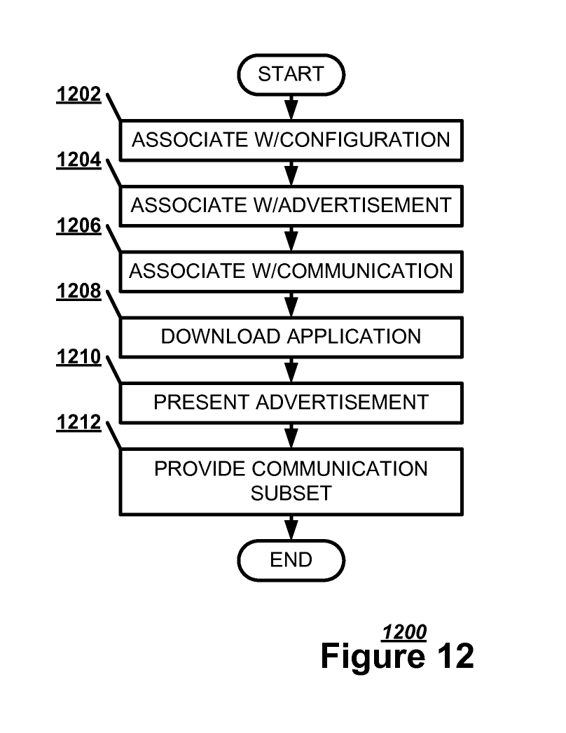

FIG. 12 illustrates, in a flowchart, one embodiment of a method 1200 of tailoring a user experience aspect with an application server. The application server may associate the user archetype with an application configuration for the application (Block 1202). The application server may associate the user archetype with an application advertisement for the application (Block 1204). The application server may associate the user archetype with an application communication subset for the application (Block 1206). The application server may download the application with an application configuration based on the user archetype to the user (Block 1208). The application server may present an application advertisement based on the user archetype for the application based on the user archetype (Block 1210). The application server may provide an application communication subset for the application to a user instance of the application based on the user archetype (Block 1212).

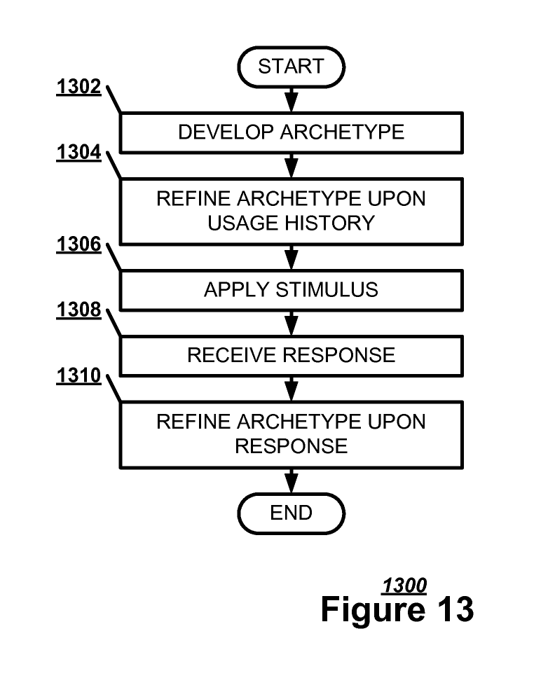

FIG. 13 illustrates, in a flowchart, one embodiment of a method 1300 of developing a user archetype. The application server or the archetype server may develop the user archetype based on at least one of a user study and a user population usage history (Block 1302). A user study is a study of the interaction between the application and a group of users under controlled conditions. A user population usage history is a history of user data usage collected under uncontrolled situations. The application server or the archetype server automatically may refine a user archetype based upon the data usage history (Block 1304). The application server automatically or the archetype server may apply an application stimulus to a user study participant of the user study (Block 1306). The application server or the archetype server may receive a stimulus response to the application stimulus from user study participant (Block 1308). The application server or the archetype server automatically may refine a user archetype based upon a stimulus response of a user study participant of the user study (1310).

Although the subject matter has been described in language specific to structural features and/or methodological acts, it is to be understood that the subject matter in the appended claims is not necessarily limited to the specific features or acts described above. Rather, the specific features and acts described above are disclosed as example forms for implementing the claims.

Embodiments within the scope of the present invention may also include computer-readable storage media for carrying or having computer-executable instructions or data structures stored thereon. Such computer-readable storage media may be any available media that can be accessed by a general purpose or special purpose computer. By way of example, and not limitation, such computer-readable storage media can comprise RAM, ROM, EEPROM, CD-ROM or other optical disk storage, magnetic disk storage or other magnetic data storages, or any other medium which can be used to store desired program code means in the form of computer-executable instructions or data structures, as opposed to propagating media such as a signal or carrier wave. Computer-readable storage media explicitly does not refer to such propagating media. Combinations of the above should also be included within the scope of the computer-readable storage media.

Embodiments may also be practiced in distributed computing environments where tasks are performed by local and remote processing devices that are linked (either by hardwired links, wireless links, or by a combination thereof) through a communications network.

Computer-executable instructions include, for example, instructions and data which cause a general purpose computer, special purpose computer, or special purpose processing device to perform a certain function or group of functions. Computer-executable instructions also include program modules that are executed by computers in stand-alone or network environments. Generally, program modules include routines, programs, objects, components, and data structures, etc. that perform particular tasks or implement particular abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Although the above description may contain specific details, they should not be construed as limiting the claims in any way. Other configurations of the described embodiments are part of the scope of the disclosure. For example, the principles of the disclosure may be applied to each individual user where each user may individually deploy such a system. This enables each user to utilize the benefits of the disclosure even if any one of a large number of possible applications do not use the functionality described herein. Multiple instances of electronic devices each may process the content in various possible ways. Implementations are not necessarily in one system used by all end users. Accordingly, the appended claims and their legal equivalents should only define the invention, rather than any specific examples given.

We claim:

1. A user device, comprising:
a memory configured to maintain a data usage history of a user;
a processing core having at least one processor configured to tailor a user experience aspect of an application based on a user archetype matched to the data usage history; and
an output device configured to present the user experience aspect of the application.

2. The user device of claim 1, wherein the at least one processor is further configured to execute an operating system to monitor the data usage history of the user.

3. The user device of claim 1, wherein the data usage history may have at least one of a default application selection, a usage time of an application instance, and a feature usage of the application instance.

4. The user device of claim 1, wherein the at least one processor is further configured to anonymize the data usage history of the user.

5. The user device of claim 1, further comprising:
a communication interface configured to send a data usage history to an application server.

6. The user device of claim 1, further comprising:
a communication interface configured to download the application with an application configuration based on the user archetype to the user.

7. The user device of claim 1, wherein the at least one processor is further configured to select an application configuration for the application based on a user archetype.

8. The user device of claim 1, further comprising:
a communication interface configured to receive an application communication subset for the application based on the user archetype.

9. The user device of claim 1, wherein the at least one processor is further configured to select an application communication from an application communication subset for the application based on the user archetype.

10. The user device of claim 1, wherein the at least one processor is further configured to automatically adjust an application configuration of the application based upon an application usage history.

11. The user device of claim 1, wherein the at least one processor is further configured to apply an application stimulus to a user.

12. The user device of claim 1, further comprising:
a communication interface configured to report a stimulus response of a user to an application server.

13. A computing device, having a memory to store a data usage history of a user received from a user device, the computing device configured to match the user to a user archetype based on the data usage history, and the computing device further configured to tailor a user experience aspect of an application based on the user archetype.

14. The computing device of claim 13, wherein the computing device is further configured to associate the user archetype with at least one of an application configuration, an application advertisement, and an application communication subset for the application.

15. The computing device of claim 13, wherein the computing device is further configured to present an application advertisement based on the user archetype for the application based on the user archetype.

16. The computing device of claim 13, wherein the computing device is further configured to develop the user archetype based on at least one of a user study and a user population usage history.

17. The computing device of claim 13, wherein the computing device is further configured automatically to apply an application stimulus to a user study participant of the user study.

18. The computing device of claim 13, wherein the computing device is further configured automatically to refine a user archetype based upon a stimulus response of a user study participant of the user study.

19. A machine-implemented method, comprising:
maintaining a data usage history of a user;
sending the data usage history for the user to an archetype server to be matched to a user archetype;
downloading the browser with an application configuration based on the user archetype of the user; and
receiving an application communication subset for the browser based on the user archetype.

20. The method of claim 19, further comprising:
adjusting, automatically, the browser configuration of the browser based upon the browser usage history.
